(19) United States
(12) Patent Application Publication
(10) Pub. No.: US 2026/0355064 A1
(43) Pub. Date: Nov. 12, 2026

(54) One-way valve system and container comprising a one-way valve system

(71) Applicant: CARAMMA APS, Kobenhavn SV (DK)

(72) Inventors: Monika Havno, Kobenhavn (DK); Rie Maktabi Grue, Kobenhavn (DK)

(21) Appl. No.: 19/488,707

(22) PCT Filed: May 31, 2024
(86) PCT No.: PCT/EP2024/064986

§ 371 Date: Nov. 28, 2025

(30) Foreign Application Priority Data
May 31, 2023 (DK) PA202330055

(51) Int. Cl. A61J 11/00; A61J 9/00; F16K 15/14

(52) U.S. Cl. CPC A61J 11/002; F16K 15/144; A61J 9/00

(57) ABSTRACT

A one-way valve system (1) includes a more-flexible membrane (2) and a less-flexible membrane (3) are adjacent to each other, wherein
the more-flexible membrane (2) includes at least one opening (2a) and the less-flexible membrane (3) comprises at least one opening (3a),
the at least two membranes (2, 3) are secured to each other along the perimeter and during a state of no pressure difference, the two membranes (2, 3) separate a first compartment (4) adjacent to the less-flexible membrane (3) from a second compartment (5) adjacent to the more-flexible membrane (2), and
when the pressure is reduced in the second compartment (5), the more-flexible membrane (2) is deformed and distanced from the less-flexible membrane (3) and liquid is allowed to flow through the openings (2a, 3a) of respectively the more-flexible membrane (2) and the less-flexible membrane (3).

The present invention relates to a medical device one-way valve made for creating an air free liquid entity and for controlling flowrate of liquid according to pressure, such as a feeding bottle for infants. More specifically, the disclosure relates to a double membrane comprising a less-flexible membrane with an opening covered by a more-flexible membrane with an opening which double membrane comprises a one-way valve.

### TECHNICAL BACKGROUND

It remains a problem that the liquid flow provided by the prior art medical devices such as feeding bottles poorly resembles the milk flow seen in natural breast feeding. Feeding bottles traditionally work with a too easily obtained milk flow; once the infant starts sucking on the teat of the feeding bottle an abundance of milk is instantaneously provided. This may at first seem like a positive trait, but the infant may become accustomed to this effortless reward, which can lead to the infant preferring the feeding bottle. Moreover, feeding bottles traditionally has air inside the container/bottle. Air is not wished to exit together with the liquid and that is avoided by positioning the liquid, so gravity brings the air away from the liquid exit, which demands pressure compensation with a vent that leads air inside the container/bottle corresponding to the quantity of liquid that is removed. The dependency of gravity leads to the usage of the liquid container being restricted by the limiting requirements for positioning. The lack of the combination of an air free system and flow control means that there is still a need for a further improved vent system for medical devices such as, but not limited to, feeding bottles.

EP 1698319 A1 discloses a baby bottle comprising a one-way valve system with two membranes. The one-way valve system comprises a rigid part 32 and a flexible membrane 311 blocking a main opening 321, and the rigid part 32 comprises emptying holes 322 permitting the returning of a liquid contained in the nipple 1 to the reservoir 21, during dismounting of the nipple. The reservoir 21 has a rigid bottom section and when a baby drinks from the bottle, the side walls of the reservoir 21 are forced together as illustrated by arrows G in FIG. 2. The deformation of the side walls during emptying allows for liquid to be isolated near the bottom of the reservoir thereby preventing liquid from leaving through the main opening 321 of the valve. The size of the opening(s) in the more-flexible membrane 311 is not deformed or in any other way limited during suction, and it is therefore not possible to control the flow through the membrane.

US 2012/0248056 A1 relates to a teat unit comprising a suction opening, a support body, and a securing part for securing the teat unit on a drinking vessel. The securing part and the support body are fixedly connected to each other indirectly or directly, and they cannot be detached from each other without being destroyed. The support body has a surface with recesses, which are covered by the teat. The teat is overmoulded over the support body, wherein the teat covers the recesses. The teat unit is of a simple construction and can be produced inexpensively, which means that it can be disposed of after one use. However, the central elevation 41 of the plate 4 forms a contact surface for the part of the more-flexible membrane 15 which surrounds the central hole 16 and when negative pressure is formed above the membrane 15, the flexible membrane 15 is pulled away from the central elevation 41 and liquid flows up through the hole 16. However, liquid may always flow in over the plate 4 either through openings along the periphery of the plate 4 or through openings in the plate 4, and if the plate 4 is provided with openings for supply of liquid, these holes are never blocked and therefore access of fluid to both the upper and lower surfaces of the plate 4 is never blocked.

The present invention addresses these problems by implementing a double membrane one-way valve system. The double membrane consists of a more-flexible membrane covering a less-flexible membrane. The flexible membrane is stretchable, and its stretch is regulated by an applied pressure difference. The more-flexible membrane has an opening in it, and the stretch of the more-flexible membrane regulates the size of the opening and adjust the distance between the more-flexible and the less-flexible membranes and thereby regulates the possible flow underneath the more-flexible membrane. The size of the opening helps regulating the flow of the liquid due to Poiseuille's law: Flow=(π/8) (Δpressure*radius⁴)/(length*viscosity). That helps solving the problem of traditional feeding bottles of poorly resembling the milk flow seen in natural breast feeding. The less-flexible membrane also has an opening in it, that is being covered by the more-flexible membrane when the more-flexible membrane is not stretched by pressure. The covering of the opening results in the liquid only being able to run one direction through the less-flexible membrane: the direction that makes the more-flexible membrane stretch itself away from the opening in the less-flexible membrane and thereby unblocking it. The one-way system helps solving the problem that traditional feeding bottles traditionally has air inside the container/bottle that limits the requirements for positioning of the bottle during feeding.

### SUMMARY OF INVENTION

It is therefore an object according to a first aspect of the invention to provide a one-way valve system for a container such as a feeding bottle providing a controlled flow of liquid out of the container.

It is a further object according to a second aspect of the invention to provide a container comprising a one-way valve.

According to the invention the object is achieved by a one-way valve system according to claim 1.

According to an embodiment, the more-flexible membrane (2) comprises an area of increased thickness (2b) and the less-flexible membrane (3) comprises an area of reduced thickness (3b) corresponding to the area of increased thickness (2b) of the more-flexible membrane (2). According to this embodiment, the corresponding areas of respectively increased and reduced thickness of the more- and less-flexible membranes may comprise or surround or be adjacent to the opening (3a) of the less-flexible membrane (3).

The area of increased thickness (2b) of more-flexible membrane (2) and the corresponding area of reduced thickness (3b) of less-flexible membrane (3) may be shaped as a heart or a triangle or a similar shape narrowing towards the centre while being broader towards the periphery.

According to an embodiment of the first aspect of the invention, the opening (2a) may be positioned at the centre of the more-flexible membrane (2) or close to the centre of the more-flexible membrane (2) where “close to” the centre of the more-flexible membrane (2) means that the centre of the opening (2a) is closer to the centre or the more-flexible membrane than to the perimeter of the more-flexible membrane (2).

According to an embodiment of the first aspect of the invention, the opening (3a) in the less-flexible membrane may be positioned closer to the perimeter of the less-flexible membrane (3) where “closer to” the perimeter means that the centre of the opening (3a) is closer to the perimeter than to the centre of the less-flexible membrane (3). Further, the centre of the opening (3a) in the less-flexible membrane may be closer to the perimeter than the opening (2a) of the more-flexible membrane (2).

According to an embodiment of the first aspect of the invention, the openings (2a, 3a) in respectively the more-flexible membrane (2) and the less-flexible membrane (3) may be positioned offset relative to each other, in such a way that the less-flexible membrane (3) blocks flow through the opening (2a) in the more-flexible membrane (2) and/or the more-flexible membrane (2) blocks flow through the opening (3a) in the less-flexible membrane (3) in a state where there is no pressure difference between the first and second compartments (4, 5).

According to an embodiment of the first aspect of the invention, the more-flexible membrane (2) in relaxed first state may comprise a circular valve opening (2a) with a diameter equal to or larger than 0.01 mm, or equal to or larger than 0.20 mm, or equal to or larger than 0.40 mm and/or a diameter equal to or smaller than 2 mm, or smaller than 1 mm, or smaller than 0.8 mm, or smaller than 0.6 mm.

According to an embodiment of the first aspect of the invention, the flow through the one-way valve system may be adapted to be at least 100 ml/5 min, and at maximum 300 ml/5 min.

According to an embodiment of the first aspect of the invention, the more-flexible membrane (2) may be made of a silicone material with a Shore A hardness in the range of 20-75, or in the range of 25-75.

According to a second aspect the invention relates to a container comprising two compartments, a first compartment (4) and a second compartment (5), wherein a one-way valve system according to the first aspect of the invention prevents gas and liquid flowing from the second compartment (5) to the first compartment (4).

According to an embodiment of the second aspect of the invention, gas and/or liquid may flow from the first compartment (4) to the second compartment (5) when the pressure is reduced in the second compartment (5) to such an extent that the more-flexible membrane (2) is deformed and distanced from the less-flexible membrane (3).

According to an embodiment of the first aspect of the invention, the container may be a feeding bottle for infants.

### BRIEF DESCRIPTION OF THE DRAWINGS

In the following, the disclosure will be described in greater details with reference to non-limiting enclosed schematic drawings, on which:

FIG. 1 shows a series of schematic cross-sections visualising of a first embodiment of a one-way valve system at different pressure situations.

FIG. 2 shows the membranes of the first embodiment in i) an exploded view of the two membranes in cross-section, ii) the two membranes seen separately from the top view, and iii) the two membranes assembled with a transparent view, illustrating how the corresponding parts of the two membranes may overlap.

FIG. 3 shows a series of schematic cross-sections visualising of a second embodiment of a one-way valve system at different pressure situations.

FIG. 4 shows the membranes of the second embodiment in i) an exploded view of the two membranes in cross-section, ii) the two membranes seen separately from the top view, and iii) the two membranes assembled with a transparent view, illustrating how the corresponding parts of the two membranes may overlap.

### DETAILED DESCRIPTION

A one-way valve system 1 according to the invention comprising at least two membranes, a more-flexible membrane 2 and a less-flexible membrane 3, when in use the one-way valve system 1 separates a first compartment 4 and a second compartment 5 of a container. The more-flexible membrane 2 comprises at least one opening 2a and the less-flexible membrane 3 comprises at least one opening 3a, the at least two membranes 2, 3 are joined or fixed to each other along the perimeter and during a first state of no pressure difference between the first and second compartments 4,5, the two membranes 2, 3 completely separates the first compartment 4 from the second compartment 5 which means that no gas or liquid flows from one compartment to the other. In this first state, the more-flexible membrane 2 and the less-flexible membrane 3 are adjacent i.e. the membranes 2, 3 are abutting and in contact with each other, normally in complete extend of their facing surfaces.

In a second state, the pressure is reduced in the second compartment 5, the more-flexible membrane 2 is deformed and distanced from the less-flexible membrane 3 while the less-flexible membrane 3 maintains its shape and position, and due to the different behaviour of the two membranes 2, 3 a third compartment 6 is created between the two membranes 2, 3. Creation of the third compartment 6 allows liquid to flow through the openings 2a, 3a of respectively the more-flexible membrane 2 and the less-flexible membrane 3 from the first compartment 4 to the second compartment 5.

In the second state, the size of the opening 2a in the more-flexible membrane 2 is increased as the area of the more-flexible membrane 2 is increased during deformation. Adapting the size of the opening 2a to the pressure difference between the first and the second compartments 4, 5 makes it possible to control the size of the flow through the one-way valve system due to Poiseuille's law: Flow=(π/8) (Δpressure*radius⁴)/(length*viscosity). The more-flexible membrane comprises extra material that covers the opening 3a in the less-flexible membrane, resulting in liquid being blocked from returning through the opening 3a in the less-flexible membrane 3 and therefore provides a one-way valve.

The more-flexible membrane 2 may comprise a circular valve opening 2a with a diameter of 0.01-2 mm, preferably 0.4-0.8 mm.

The more-flexible membrane 2 may have an optimal flow through the opening at a vacuum pressure in the range of 10-350 mm Hg, e.g. in the range of 90-250 mm Hg, and when providing a vacuum pressure in the range of 90-250 mm a maximum a liquid flow of 100-300 ml/5 min is provided.

Experiments have shown that this combination of features of the present invention may provide valve characteristics resembling the resistance to milk flow during natural breast feeding. The at least one opening 2a in the more-flexible membrane is preferably the only liquid inlet/outlet through the more-flexible membrane 2. The at least one opening 2a of the more-flexible membrane 2 may be a circular opening with a diameter in the range 0.05-2.0 mm in the non-stretched state of the membrane. The at least one opening 2a may be created while the more-flexible membrane 2 is being stretched, resulting in the opening being smaller or closed in the non-stretched first state of the more-flexible membrane 2.

The flow of liquid out of a feeding bottle is regulated by the reduction of pressure created in the second compartment 5 when an infant starts sucking. The reduced pressure draws liquid from the first compartment 4 through the one-way valve 2b and creates a third compartment 6 between the two membranes.

The one-way valve 2b may be constituted of a part of the more-flexible membrane 2—or be fixed/secured to—the more-flexible membrane 2. The one-way valve 2b may simply comprise the smooth, corresponding surface of the more-flexible membrane 2 which upon contact closes the opening 3a of the less-flexible membrane 3. However, the one-way valve 2b may alternatively comprise a thickening or a protruding part of the more-flexible membrane 2 or a separate part attached to the more-flexible membrane 2.

The more-flexible membrane 2 is fixed to the less-flexible membrane 3 by a securing portion. The securing portion may comprise a recess at the edge of the more-flexible membrane 2 matching a projecting edge or flange on the less-flexible membrane 3. Alternatively, the membranes 2 3 may be fixed indirectly, for example by being clamped together each with a securing flange between a coupling element.

The more-flexible membrane 2 may be made of a silicone material with a Shore A hardness in the range of 20-75. The more-flexible membrane 2 may be made of a hydrophobic material to facilitate liquid flow and/or cleaning. The more-flexible membrane 2 may have a size in its non-stretched state in the range of 5-100 cm² or 10-100 cm². The more-flexible membrane 2 may in a first relaxed state have substantially the same size as the opening of the container where it is positioned.

The advantages provided by the one-way valve system according to the invention applies independently of the embodiment of other parts of the device in which the membrane is mounted.

The less-flexible membrane 3 may be made of a polymer material, such as silicone, rubber or plastic, stiffer than the material of the more-flexible membrane. The less-flexible membrane 3 may have a size of 5-100 cm², or 10-100 cm² and may have substantially the same size as the container opening in which it is used. The less-flexible membrane 3 may have the form of a disk, and/or may have a thickness in the range of 0.1-60 mm.

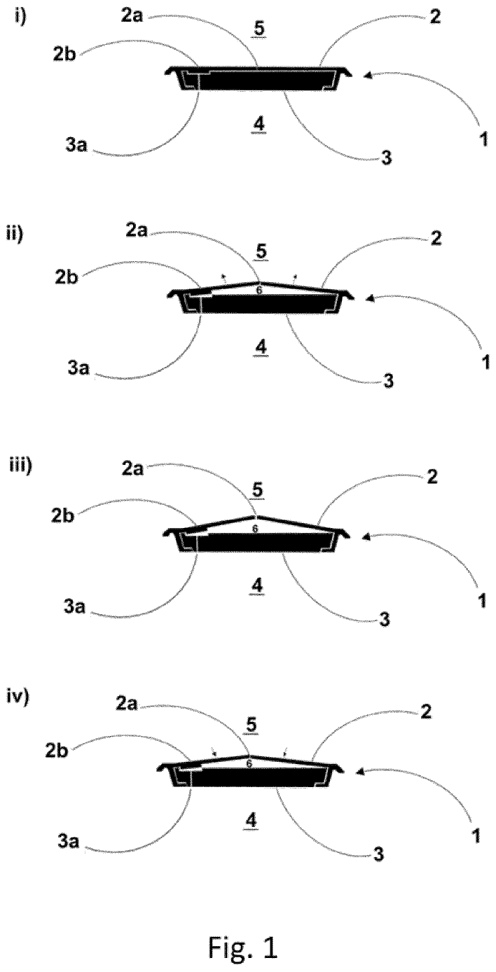

FIG. 1 shows a double membrane one-way valve system 1 according to the invention at different pressure situations. In this embodiment the more-flexible membrane 2 has only one opening 2a which is positioned centrally. The less-flexible membrane 3 is in this embodiment depicted inside the more-flexible membrane 2, and the less-flexible membrane has an opening 3a, that together with the opening in the more-flexible membrane connects the liquid from the first compartment of liquid 4 to the second compartment of liquid 5 when the one-way valve 2b is open. The liquid container defining the first compartment 4 and the liquid container with the exit defining the second compartment 5 are not shown, as its shape is not of importance to the function of the one-way valve system 1.

In this embodiment the one-way valve 2b is mounted on the more-flexible membrane 2 and extends in parallel with the more-flexible membrane 2 due to the pressure difference between the first compartment of liquid 4 and the second compartment of liquid 5.

In i) the more-flexible membrane 2 and the one-way valve 2b is not lifted, due to the absence of pressure difference between the first compartment of liquid 4 and the second compartment of liquid 5.

In ii) the more-flexible membrane 2 and the one-way valve 2b has been lifted due to a suction pressure being applied to the second compartment of liquid 5 resulting in formation of a third compartment of liquid 6 between the more-flexible membrane 2 and the less-flexible membrane 3. An opening 2a in the more-flexible membrane 2 has opened due to the expansion of the more-flexible membrane 2, said opening allowing liquid to flow from the third compartment of liquid 6 to the second compartment of liquid 5.

In iii) a maximum pressure has been applied. The opening 2a in the more-flexible membrane 2 is now at the same size as the opening 3a in the less-flexible membrane 3. The opening 2a in the more-flexible membrane 2 is now fully extended and a maximum size of the opening 2a is achieved, allowing a maximum flow from the first compartment of liquid 4, through third compartment of liquid 6 to second compartment of liquid 5.

In iv) the suction pressure in the second compartment of liquid 5 stops, the content of the third compartment 6 is pressed towards the opening 3a in the less-flexible membrane 3, until the one-way valve 2b starts covering it, and afterwards the remaining liquid will be pressed out of the opening 2a in the more-flexible membrane 2.

At the beginning of exiting the liquid it may be necessary to push out any air present as air-pockets from the first compartment of liquid 4 by putting pressure on the first compartment of liquid 4. This will result in the more-flexible membrane 2 being lifted together with the one-way valve 2b removing it from covering the opening 3a in the less-flexible membrane 3 in the same way as shown in ii).

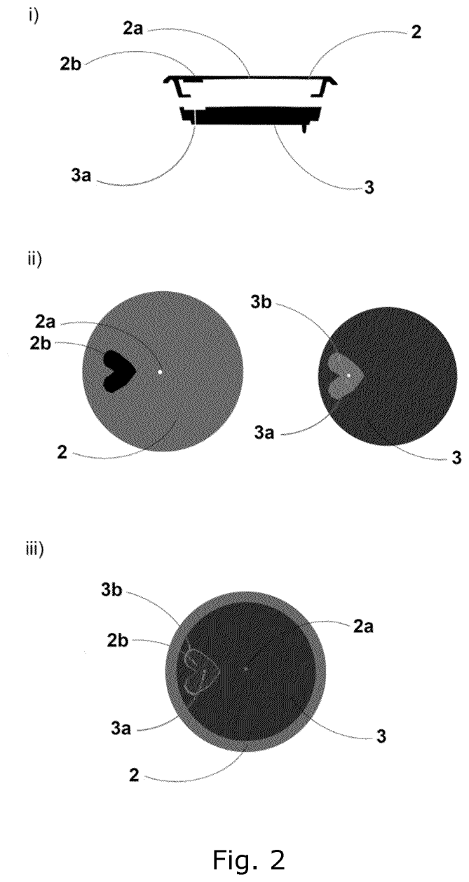

FIG. 2 shows an embodiment of a one-way valve 2b according to the invention comprising an area of material having an increased thickness on the more-flexible membrane 2 fitting into or corresponding to an excavation 3b or stretched across a top point 3b of the less-flexible membrane 3 having a reduced thickness and having the same shape as the area of increased thickness in the more-flexible membrane 2, or alternatively having an area of material overlap with the more-flexible membrane 2. The one-way valve works by blocking liquid from running back into the container when the pressure difference between the first compartment 4 and the second compartment 5 is reduced to a minimum limit.

FIG. 2 i) shows the two membranes, i.e., the more-flexible membrane 2 and the less-flexible 3 in a cross-sectional view, FIG. 2 ii) shows separated top views of each of the two membranes 2, 3, and FIG. 2 iii) shows a transparent top view of the two membranes 2, 3 in assembled form.

The top views illustrate how corresponding parts of the two membranes 2, 3 together provide a one-way valve 2b, the opening 2a through the more-flexible membrane 2 near the centre of the more-flexible membrane 2, the opening 3a through the less-flexible membrane 3 and the excavation in the shape of the one-way valve 2b overlap. The one-way valve 2b is a plug that consists of extra material on a smaller part of the more-flexible membrane 2, in this case a heart shape.

Extra material constituting a part of the one-way valve 2b on the more-flexible membrane 2 is pressed into an excavation 3b in the less-flexible membrane 3. The excavation 3b is corresponding the shape of the extra material 2b on the more-flexible membrane 2, e.g. a heart shape. The depth of the excavation 3b in the less-flexible membrane 3 is smaller than the height of the extra material 2b on the more-flexible membrane 2, resulting in more pressure on the one-way valve 2b by the more-flexible membrane 2 when it is assembled and fitting into the less-flexible membrane 3. The extra material being the one-way valve 2b on the more-flexible membrane 2 covers the opening through the less-flexible membrane 3a. The opening 3a through the less-flexible membrane 3 is normally positioned closer to the perimeter of the two membranes 2, 3, where the membranes are assembled, than to the centre.

The position of the one-way valve 2b determines when this part of the more-flexible membrane 2 touches the surface of the less-flexible membrane as soon as the more-flexible membrane returns to its relaxed position, blocking liquid from running back into the container through the opening through the less-flexible membrane 3a.

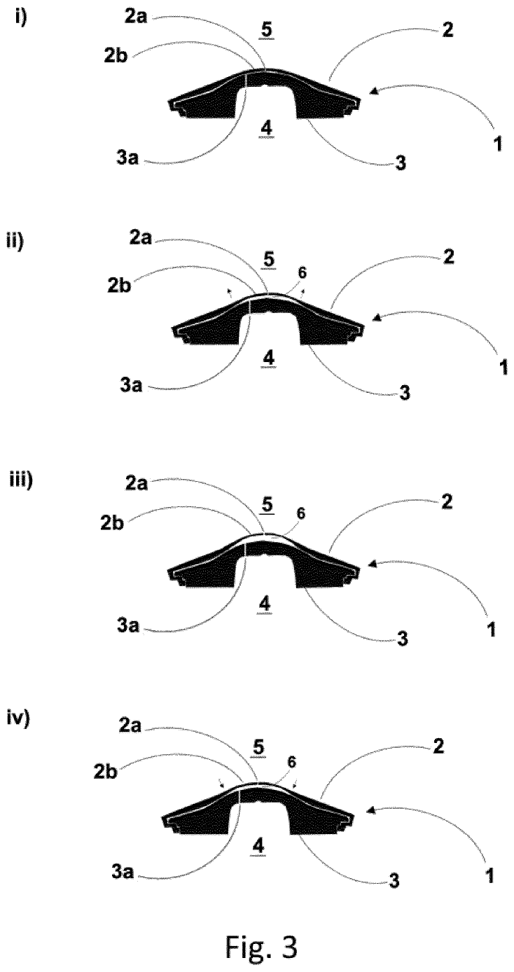

FIG. 3 shows a second embodiment of a double membrane one-way valve system 1 according to the invention at different pressure situations. Similar parts are provided with the same reference numbers as used for the first embodiment. Also, according to this embodiment, the more-flexible membrane 2 has one opening 2a positioned centrally. The less-flexible membrane 3 is in this embodiment depicted partly inside and partly below the more-flexible membrane 2. The less-flexible membrane 3 has one opening 3a, that together with the opening in the more-flexible membrane connects the liquid from the first compartment of liquid 4 to the second compartment of liquid 5 when the one-way valve 2b is opened. The liquid container defining the first compartment 4 and the liquid container with the exit defining the second compartment 5 are not shown.

According to this embodiment, the one-way valve 2b comprises an area where the more-flexible membrane is fitted or stretched across a top point i.e. a raised area, of the less-flexible membrane 3b. The area where the more-flexible membrane 2 is stretched across the top point in the less flexible membrane 3b is an area where the top point in the geometry of the more-flexible membrane 2b is parallel to or lower than the top point in the geometry of the less-flexible membrane 3b. Ther is thus created a material pressure between the top point of the more-flexible membrane 2 and the top point of the less-flexible membrane 3, so surfaces of the two membranes touches each other when the more flexible membrane 2 is in a relaxed state or position.

The FIG. 3 i), ii), iii) and iv) disclose the following states of the one-way valve system of the second embodiment:

In i) the more-flexible membrane 2 and the one-way valve 2b is not lifted due to the absence of pressure difference between the first compartment of liquid 4 and the second compartment of liquid 5.

In ii) the more-flexible membrane 2 and the one-way valve 2b are separated from the less-flexible membrane 3 due to a suction pressure being applied to the second compartment of liquid 5 resulting in formation of a third compartment of liquid 6 between the more-flexible membrane 2 and the less-flexible membrane 3. An opening 2a in the more-flexible membrane 2 is opened due to the expansion of the more-flexible membrane 2, said opening allowing liquid to flow from the third compartment of liquid 6 to the second compartment of liquid 5.

In iii) a maximum pressure has been applied resulting in a maximum separation of the more-flexible membrane 2 from the less-flexible membrane 3. The opening 2a in the more-flexible membrane 2 is now at the same size as the opening 3a in the less-flexible membrane 3, i.e. the opening 2a in the more-flexible membrane 2 is fully extended and a maximum size of the opening 2a is achieved, allowing a maximum flow from the first compartment of liquid 4, through the third compartment of liquid 6 to second compartment of liquid 5.

In iv) the suction pressure in the second compartment of liquid 5 stops, the content of the third compartment 6 is pressed towards the opening 3a in the less-flexible membrane 3, until the one-way valve 2b starts covering it, and afterwards the remaining liquid will be pressed out of the opening 2a in the more-flexible membrane 2.

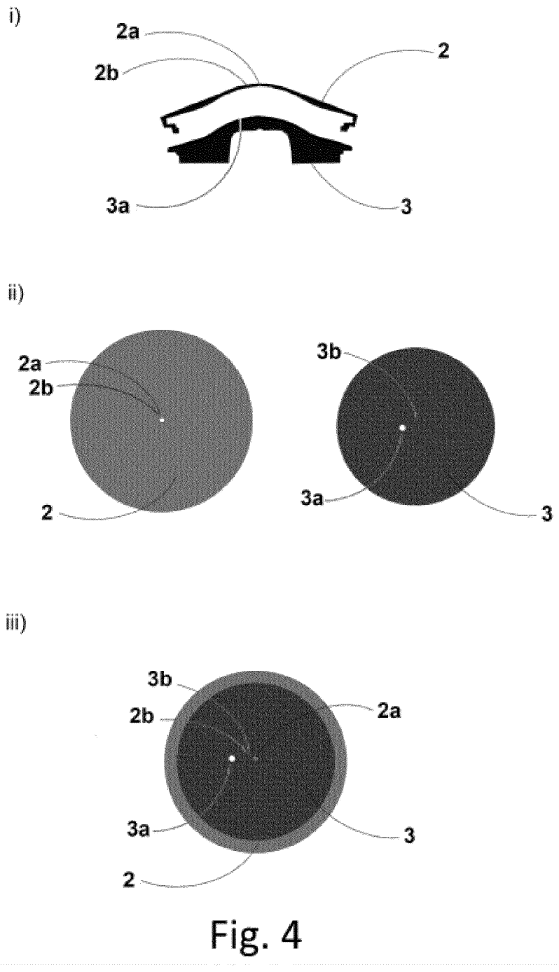

FIG. 4 shows the membranes of the second embodiment in i) an exploded view of the two membranes in cross-section, ii) the two membranes seen separately from the top view, and iii) the two membranes assembled in a transparent view, illustrating how the corresponding parts of the two membranes may overlap. FIG. 4 ii) and iii) shows how the opening 3a of the less-flexible membrane 3 is positioned closer to the centre and to the opening 2a of the more-flexible membrane than to the perimeter of the two membranes 2, 3, where the membranes are assembled.

In general, the horizontal—or radial distance—between the opening 2a of the more-flexible membrane 2 and the opening 3a of the less-flexible membrane 3 is adapted to the profile of the less-flexible membrane, i.e. whether the outer surface of the less-flexible membrane 3 is flat or comprise protruding areas, and the flexibility of the more-flexible membrane 2.

When the less-flexible membrane 3 has a protruding part with a top point, then this top point will normally be positioned at the centre of the less-flexible membrane 3 and the opening 2a of the less-flexible membrane 2 may be positioned just above or outside this top point which means off-set this top point or closer to the perimeter than the top point.

In general, the less-flexible membrane 3 may define the profile of the combined membranes 2, 3, in a cut-through view. In general, the more-flexible membrane 2 may adapt to the shape of the less-flexible membrane 3 due to its elasticity.

In general, the less-flexible membrane 3 may have a flat or plane upper surface, i.e. a straight surface without protruding parts, where the upper surface of the less-flexible membrane 3 is the surface facing the more-flexible membrane 2 in a use-situation, or the less-flexible membrane 3 may comprise an upward curved or rounded or protruding upper surface i.e. a convex surface, and the highest point of the curved or rounded upper surface may be positioned at or near the centre of the membrane upper surface, where “near” the centre is understood as being within 0.1×outer diameter of the less-flexible membrane 3.

| Ref. no. | Name |
|---|---|
| 1 | One-way valve system |
| 2 | More-flexible membrane |
| 2a | Opening through more-flexible membrane |
| 2b | Part of one-way valve of more-flexible membrane |
| 3 | Less-flexible membrane |
| 3a | Opening through less-flexible membrane |
| 3b | Part of one-way valve of less-flexible membrane |
| 4 | First compartment of container |
| 5 | Second compartment of container |
| 6 | Third compartment between membranes |

1. A one-way valve system (1) comprising at least two membranes, a more-flexible membrane (2) and a less-flexible membrane (3) wherein the material of the less-flexible membrane (3) is stiffer than the material of the more-flexible membrane (2) and which more-flexible membrane (2) and less-flexible membrane (3) are adjacent i.e. the membranes (2, 3) are abutting and in contact with each other in complete extend of their facing surfaces,
the more-flexible membrane (2) comprises at least one opening (2a) and the less-flexible membrane (3) comprises at least one opening (3a),
the at least two membranes (2, 3) are secured to each other along the perimeter and during a state of no pressure difference, the two membranes (2, 3) separate a first compartment (4) adjacent to the less-flexible membrane (3) from a second compartment (5) adjacent to the more-flexible membrane (2),
when the pressure is reduced in the second compartment (5), the more-flexible membrane (2) is deformed and distanced from the less-flexible membrane (3) and liquid is allowed to flow through the openings (2a, 3a) of respectively the more-flexible membrane (2) and the less-flexible membrane (3),
characterized in that the size of the opening (2a) in the more-flexible membrane (2) is increased and/or a passage between the membranes (2, 3) is increased when the more-flexible membrane (2) is deformed.

2. The one-way valve system (1) according to claim 1, wherein the opening (2a) is positioned at the center of the more-flexible membrane (2) or close to the center of the more-flexible membrane (2) where close to the center of the more-flexible membrane (2) means closer to the center than to the perimeter of the more-flexible membrane (2).

3. The one-way valve system (1) according to claim 1, wherein the opening (3a) in the less-flexible membrane is positioned close to the perimeter of the less-flexible membrane (3) where “close to the perimeter” means that the opening (3a) is closer to the perimeter than to the center of the less-flexible membrane.

4. The one-way valve system (1) according to claim 1, wherein the opening (3a) in the less-flexible membrane is positioned close to the center of the less-flexible membrane (3) where “close to the center” means that the opening (3a) is closer to the center than to the perimeter of the less-flexible membrane.

5. The one-way valve system (1) according to claim 1, wherein the openings (2a, 3a) in respectively the more-flexible membrane (2) and the less-flexible membrane (3) are offset relative to each other, in such a way that the less-flexible membrane (3) blocks flow through the opening (2a) in the more-flexible membrane (2) and the more-flexible membrane (2) blocks flow through the opening (3a) in the less-flexible membrane (3) in a state where there is no pressure difference between the first and second compartments (4, 5).

6. The one-way valve system (1) according to claim 1, wherein either the less-flexible membrane (3) or the more-flexible membrane (2) comprises a protruding part which assists blocking entrance of liquid into a third compartment (6) between the less-flexible and more-flexible membranes (3, 2).

7. The one-way valve system (1) according to claim 1, wherein either the less-flexible membrane (3) comprises a protruding part comprising a top point positioned centrally relative to the perimeter of both the less-flexible membrane (3) and the more-flexible membrane (2)

8. The one-way valve system (1) according to claim 1, wherein the more-flexible membrane (2) in relaxed first state comprises a circular valve opening (2a) with a diameter equal to or larger than 0.01 mm, or equal to or larger than 0.20 mm, or equal to or larger than 0.40 mm and/or a diameter equal to or smaller than 2 mm, or smaller than 1 mm, or smaller than 0.8 mm, or smaller than 0.6 mm.

9. The one-way valve system (1) according to claim 1, wherein the flow through the one-way valve system is at least 100 ml/5 min and at maximum 300 ml/5 min at a pressure of 90 mm Hg in the second compartment (5).

10. The one-way valve system (1) according to claim 1, wherein the more-flexible membrane (2) is made of a silicone material with a Shore A hardness in the range of 20-75, or in the range of 25-75.

11. A container comprising two compartments, a first compartment (4) and a second compartment (5), wherein the one-way valve system (1) according to claim 1 prevents gas and liquid flowing from the second compartment (5) to the first compartment (4).

12. The container according to claim 11, wherein gas and/or liquid flows from the first compartment (4) to the second compartment (5) when the pressure is reduced in the second compartment (5) to such an extent that the more-flexible membrane (2) is deformed and distanced from the less-flexible membrane (3).

13. The container according to claim 11, wherein the container comprises a feeding bottle for infants.
